(19) United States
(12) Patent Application Publication
(10) Pub. No.: US 2003/0112199 A1
(43) Pub. Date: Jun. 19, 2003

(54) RF antenna

(76) Inventors: Ayoub Annabi, Dole (FR); Roland Vincent, Dole (FR); Frederic Diximus, Dole (FR)

Correspondence Address: BLANK ROME COMISKY & MCCAULEY, LLP, 900 17TH STREET, N.W., SUITE 1000, WASHINGTON, DC, 20006, US

(21) Appl. No.: 10/293,303

(22) Filed: Nov. 14, 2002

(30) Foreign Application Priority Data
Nov. 16, 2001 (FR) 01 14824

(51) Int. Cl. H01Q 21/00; H01Q 21/12

(52) U.S. Cl. 343/810; 343/814

(57) ABSTRACT

The invention provides an elongate antenna. The radiating portion of the antenna is constituted by an elongate conductor element which is machined to constitute:

N dipoles (where N is an integer not less than 2) made up of N rectilinear sections of said element in alignment; and

N-1 phase-shifter elements, each phase-shifter element being interposed between two consecutive dipoles, each phase-shifter element being constituted by a section of said elongate conductor element folded into a U-shape having branches which are substantially juxtaposed and which extend in a direction that is orthogonal to the common direction of said dipoles.

The present invention relates to an elongate antenna, and particularly but not exclusively to an antenna of this type capable of receiving and transmitting in frequency bands at 1 GHz or higher.

### BACKGROUND OF THE INVENTION

A new IEEE standard No. 802.11A or B has come into force concerning the implementation of communications by radio. There are several reasons at the origin of that standard: firstly, there was a desire to have mobile data capture systems capable of working in complete freedom relative to a fixed network; and secondly there was a desire to eliminate numerous cabling operations when installing new applications.

### OBJECTS AND SUMMARY OF THE INVENTION

To satisfy those requirements, it is necessary to have an antenna capable of operating at a high frequency, and in particular at a frequency greater than 1 GHz, which antenna should also present high gain. In addition, it is necessary for the antenna to be suitable for being made by low-cost industrial techniques so as to keep the cost of the antenna down, and it is also necessary for the antenna to be fed by means of a coaxial cable.

According to the invention, this object is achieved by an elongate antenna wherein its radiating portion is constituted by an elongate conductor element which is machined so as to make up:

N dipoles (where N is an integer not less than 2) made up of N rectilinear sections of said element in alignment; and

N-1 phase-shifter elements, each phase-shifter element being interposed between two consecutive dipoles, each phase-shifter element being constituted by a section of said elongate conductor element folded into a U-shape with branches which are substantially juxtaposed and which extend in a direction that is orthogonal to the common direction of said dipoles, said radiating element being connected at one of its ends to the central conductor of a coaxial cable;

said coaxial cable is provided close to its end connected to the antenna with means forming an impedance-matching cavity; and

said coaxial cable is provided close to the impedance-matching cavity on its side remote from the antenna with means constituting a trap for leakage currents.

It will be understood firstly that the antenna can be made at low cost since it suffices to start from a wire element, preferably a single wire element, and to fold it in such a manner as to obtain the N rectilinear dipoles and the N-1 U-shaped phase shifters.

It will also be understood that in spite of its low cost, because of the presence of a plurality of dipoles, it is possible to increase gain in the direction orthogonal to the radiating elements and to obtain a passband of sufficient width to enable all of the bands allocated by the above-mentioned IEEE standard to be accommodated, thus making it possible to achieve transmission or reception at a high data rate of the order of several tens of megabits per second (Mbit/s) if a passband of about 500 MHz is used.

Preferably, the length of each dipole is equal to λ/2 and the length of each branch of the phase-shifter element is equal to λ/4, where λ is the wavelength of the center frequency of the frequency band in which the antenna operates.

With these characteristics, an antenna is obtained having dimensions that are relatively small for the above-specified band while nevertheless presenting gain and bandwidth that are satisfactory.

Preferably, the radiating portion is constituted by a single elongate conductor element, folded to form the phase shifters. This solution is particularly low in cost.

### BRIEF DESCRIPTION OF THE DRAWINGS

Other characteristics and advantages of the invention appear better on reading the description below of an embodiment of the invention given as non-limiting examples. The description refers to the accompanying figures, in which:

FIG. 1 is a diagrammatic overall view of the antenna; and

FIG. 2 is a detail view showing a preferred form of connection between the radiating portion and the coaxial cable.

### MORE DETAILED DESCRIPTION

As already mentioned, the elongate antenna of the invention can be made from a single elongate conductor element which is subjected to machining operations that are very simple since they are constituted merely by operations of folding the conductor in order to obtain the various portions constituting the antenna described below. This elongate element can be constituted, for example, by a strip of brass, preferably a surface-treated strip.

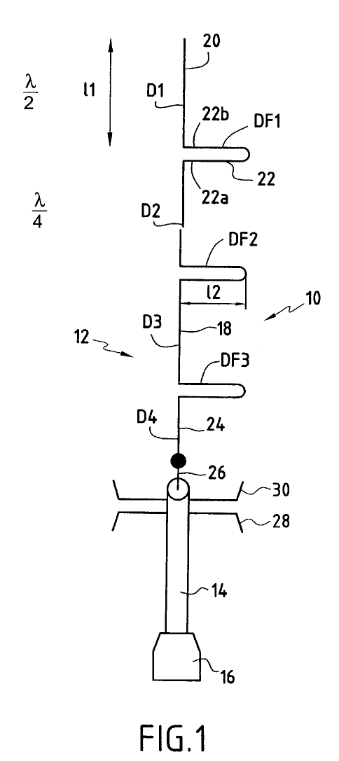

Accompanying FIG. 1 shows an embodiment of the antenna 10 with its transmission-and-reception portion 12, its antenna conductor 14 constituted by a coaxial cable, and its connector 16. The transmission-and-reception portion 12 or “radiating” portion of the antenna is preferably made from a single conductive strip 18 of constant right section. It would not go beyond the invention for the antenna to be made up of a plurality of interconnected conductor elements having different sections, for example. The element 18 is folded in the embodiment described so as to constitute dipoles D1, D2, D3, . . . , D_{N} and phase shifters DF1, DF2, DF3, . . . , DF_{N}′. Each dipole D is constituted by a rectilinear portion of conductor strip 20 of length l1 corresponding to λ/2, where λ is the center wavelength of the transmission-reception frequency band. All of the dipoles are identical and in alignment.

Each phase-shifter element DF interposed between two dipoles is constituted by a U-shaped portion of conductor strip 22 having two branches 22a and 22b which are substantially juxtaposed extending in a common direction that is substantially orthogonal to the common direction of the dipoles D. The length l2 of each branch of the phase-shifter circuit DF is equal to λ/4 where λ has the same value as for the dipoles.

Given their direction, the phase shifters DF can be considered as acting neither as transmission radiating elements nor as reception radiating elements. They perform a phase-shifting function.

The bottom dipole D4 is electrically connected at point 24 to the center conductor 26 of the antenna coaxial cable 14.

The elongate element or strip used for making the transmission-reception portion 12 of the antenna preferably presents a right section that is rectangular being about 4 millimeters (mm) in width. This section serves to increase the width of the passband and ensures that the antenna has appropriate mechanical properties.

In a preferred embodiment which corresponds to a working frequency band lying in the range 5.725 GHz to 5.875 GHz, the physical length of the dipoles D is equal to 26 mm and the total physical length of the U-shaped phase shifters is equal to 26 mm.

In the example described, there are four dipoles D1, D2, D3, and D4, which corresponds to a good compromise between the antenna having sufficient gain and also being acceptably compact. Nevertheless, it is naturally possible to select a value for N other than 4. Similarly, it is possible to select a value for N′ that is other than 3.

Naturally, the design of this antenna is suitable for the following frequency bands:

5.250 GHz to 5.350 GHz;

5.350 GHz to 5.470 GHz;

5.470 GHz to 5.720 GHz.

In the above-described embodiment, all of the dipoles D are of the same length and that length corresponds to half the center wavelength λ.

To further broaden the bandwidth of the antenna, it is possible for each dipole D1, D2, D3, and D4 to be given an electrical length corresponding to respective wavelengths λ1, λ2, λ3, λ4 that are offset relative to one another.

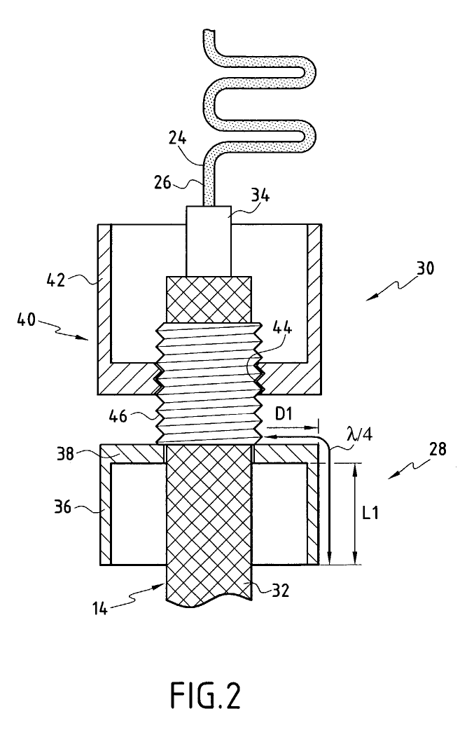

FIG. 2 shows a preferred embodiment of a current trap 28 and an impedance matcher 30 in greater detail.

This figure shows the coaxial cable 14 with its shielding 32, its intermediate insulation 34, and its axial conductor 26 which is connected to the end 24 of the radiating element of the antenna.

The current trap 28 is constituted by a conductive cylinder 36 disposed coaxially about the cable 14, being downwardly open and connected at its top end to the shielding 32 by a conductive ring 38. The length L1 of the cylinder and the width D₁ of the ring are such that D₁+L₁=λ/4 where λ is the operating wavelength.

Impedance matching 30 is performed by means of a conductive cylinder 40 whose bottom end is connected to a conductive ring 42 presenting axial tapping 44. The tapping 44 co-operates with a threaded ring 46 mounted on the coaxial cable.

By adjusting the axial position of the cylinder 40 relative to the end of the coaxial cable 14, it is possible to adapt the impedance of the radiating element so that it matches that of the cable.

What is claimed is:

1/ An elongate antenna wherein its radiating portion is constituted by an elongate conductor element which is machined so as to make up:
N dipoles (where N is an integer not less than 2) made up of N rectilinear sections of said element in alignment; and
N-1 phase-shifter elements, each phase-shifter element being interposed between two consecutive dipoles, each phase-shifter element being constituted by a section of said elongate conductor element folded into a U-shape with branches which are substantially juxtaposed and which extend in a direction that is orthogonal to the common direction of said dipoles, said radiating element being connected at one of its ends to the central conductor of a coaxial cable;
said coaxial cable is provided close to its end connected to the antenna with means forming an impedance-matching cavity; and
said coaxial cable is provided close to the impedance-matching cavity on its side remote from the antenna with means constituting a trap for leakage currents.

2/ An antenna according to claim 1, wherein the length of each dipole is equal to λ2 and the length of each branch of the phase-shifter element is equal to λ4, where λ is the wavelength of the center frequency of the frequency band in which the antenna operates.

3/ An antenna according to claim 1, wherein the radiating portion is constituted by a single elongate conductor element, folded to form said phase shifters.

4/ An antenna according to claim 1, wherein the radiating portion of the antenna is made from a single conductive strip of constant right section which is folded to form the phase shifters.

5/ An antenna according to claim 1, wherein each dipole is of a different physical length, said wavelengths being included within a given band of wavelengths.
